(19) United States
(12) Patent Application Publication
(10) Pub. No.: US 2026/0067143 A1
(43) Pub. Date: Mar. 5, 2026

(54) BACKSCATTERING SIGNAL TRANSMISSION AND RECEPTION USING 2 K-PSK MODULATION AND/OR MULTIPLE ACCESS TECHNIQUES

(71) Applicant: Telefonaktiebolaget LM Ericsson (publ), Stockholm (SE)

(72) Inventors: Miguel LOPEZ, Herzogenrath (DE); Ning HE, Stockholm (SE)

(21) Appl. No.: 19/106,764

(22) PCT Filed: Aug. 26, 2022
(86) PCT No.: PCT/SE2022/050769

§ 371 Date: Feb. 26, 2025

(51) Int. Cl. H04L 27/26; H04B 5/77; H04L 27/20

(52) U.S. Cl. CPC H04L 27/26025; H04B 5/77; H04L 27/2071

(57) ABSTRACT

Systems and methods are disclosed for transmission and reception of backscattering signals using 2K Phase Shift Keying (PSK) (2K-PSK) modulation and/or multiple access techniques.

### TECHNICAL FIELD

The present disclosure relates to transmission and reception of a wireless signal via backscattering.

### BACKGROUND

Passive and semi-passive transmitters are very attractive for ultra-low-power Internet of Things (IoT) applications. Passive transmitters are powered entirely by the energy received from an incoming wireless signal. Semi-passive transmitters have a battery and consume power to perform baseband processing but lack a power amplifier and many other components present in a conventional radio frequency (RF) transmitter chain.

Passive and semi-passive transmitters transmit a signal using a technique referred to as backscattering. With backscattering, generation of the RF carrier is delegated to an external node that is not power constrained. This implies that no power-hungry power amplifiers, filters, mixers, and other components are needed in the passive or semi-passive transmitter. Instead, a passive or semi-passive transmitter generates a transmit signal by using an antenna mismatched to the incoming wireless carrier, thus reflecting or backscattering the incoming wireless signal. Further, by modulating the reflected, or backscattered, signal, data is transmitted to a receiving device.

FIG. 1 illustrates one example of a passive transmitter. In this example, there are two antenna impedances, labeled Z₁ to Z₂, and one switch. The rate at which switching occurs has an effect on the characteristics of the backscattered signal, or scattered radio waves. For example, a baseband signal generator of the passive transmitter creates a signal that has a pre-determined frequency Δf. When this signal modulates the state of the switch, the resulting effect is the mixing of the frequency of the impinging wireless signal with the frequency Δf. This yields the reflection of two images of the impinging wireless signal, where these images have frequency offsets ±Δf added to the frequency of the impinging wireless signal, as illustrated in FIG. 2. In FIG. 2, the impinging wireless signal includes two frequency components (e.g., subcarriers), as indicated by the two vertical arrows. For each frequency component, the two images are located at the frequency locations indicated by the respective dotted arrow.

The use of Orthogonal Frequency Division Multiplexing (OFDM) signals from Institute of Electrical and Electronics Engineers (IEEE) 802.11 (commonly known as “Wi-Fi”) to illuminate passive or semi-passive transmitters (i.e., backscattering transmitters) has been proposed in the context of ambient backscattering (e.g., backscattering of Wi-Fi signals) in U.S. Pat. No. 11,201,775B2 (hereinafter referred to as “the '775 Patent).

The '775 Patent proposed the use of a special type of OFDM signal that helps mitigate the problems of self-interference or of direct path interference from the transmitter. The basic idea is that the carrier emitter transmits an OFDM signal having a comb pattern in the frequency domain, as illustrated in FIG. 3. If the backscattering transmitter switches at a rate equal to the subcarrier spacing, then the impinging wireless signal shown in FIG. 3 is frequency translated, and the backscattered signal is as shown in FIG. 4. The advantage of this technique is that the signal from the carrier emitter and the backscattered signal are orthogonal in the frequency domain.

Notwithstanding the advantages of the technique proposed in the '775 Patent, there is still a need for systems and methods that provide backscattering techniques that enable use cases such as, e.g., the use of backscattering devices in licensed frequency spectrum, the use of backscattering devices in an environment in which many devices may be operating in close proximity to one another, etc.

### SUMMARY

Systems and methods are disclosed for transmission and reception of backscattering signals using 2^{K} Phase Shift Keying (PSK) (2^{K}-PSK) modulation and/or multiple access techniques.

In one embodiment, a method performed by a device for transmitting data using a 2^{K}-PSK modulation scheme comprises exposing an antenna of the device to an incident wireless signal, the incident wireless signal being a multi-subcarrier wireless signal comprising a plurality of active subcarriers and at least two inactive subcarriers between at least one pair of adjacent active subcarriers from among the plurality of active subcarriers. The method further comprises generating a binary sequence that comprises N repetitions of a 2^{K}-PSK representation of K information or code bits, the 2^{K}-PSK representation of the K information or code bits comprising one of 2^{K} cyclic shifts of a base sequence of 2^{K-1} zeros followed by 2^{K-1} ones that is mapped to a particular binary sequence formed by the K information or code bits, wherein K is a positive integer value that is greater than or equal to 1 and N is a positive integer value that is greater than or equal to 1. The method further comprises, while exposing the antenna of the device to the incident wireless signal, modulating an impedance of the antenna between a first impedance value and a second impedance value at a switching rate that is R times a subcarrier spacing of the incident wireless signal in accordance with the generated binary sequence to thereby provide a backscattered signal that is modulated in accordance with a 2^{K}-PSK modulation scheme, wherein R is a positive even integer. In this manner, transmission of a backscattering signal using a 2^{K}-PSK modulation scheme is provided.

In one embodiment, the incident wireless signal is a multi-subcarrier wireless signal comprising the plurality of active subcarriers and at least two inactive subcarriers between each pair of adjacent active subcarriers from among the plurality of active subcarriers.

In one embodiment, for each active subcarrier of the plurality of active subcarriers of the incident wireless signal, the backscattered signal comprises signal components located at f_{sc}±the switching rate, where f_{sc} is a center frequency of the active subcarrier.

In one embodiment, mappings between different binary sequences of K information or code bits and the 2^{K} cyclic shifts of the base sequence are predefined or preconfigured.

In one embodiment, at least one of N, K, and the switching rate is predefined or preconfigured for the device.

In one embodiment, the method further comprises receiving, from a control node, information that configures at least one of N, K, and the switching rate for the device.

In one embodiment, the switching rate used by the device is different than a switching rate used by another device that simultaneously operates on the same incident wireless signal.

Corresponding embodiments of a device for transmitting data using a 2^{K}-PSK are also disclosed.

Embodiments of a method performed by a receiving device for reception of a backscattered signal from a device where the backscattered signal is modulated using a 2^{K}-PSK modulation scheme are also disclosed. In one embodiment, the method performed by the receiving device comprises receiving a composite wireless signal, the composite wireless signal comprising a superposition of a first wireless signal from a transmitter device and a backscattered signal from a device, wherein the composite wireless signal is a multi-subcarrier wireless signal and the backscattered signal is modulated in accordance with 2^{K}-PSK modulation scheme. The method further comprises demodulating the backscattered signal.

In one embodiment, the composite wireless signal comprises a first set of subcarriers and a second set of subcarriers. The first set of subcarriers correspond to a plurality of active subcarriers of the first wireless signal, the first wireless signal comprising the plurality of active subcarriers and at least two inactive subcarriers between each pair of adjacent active subcarriers. The second set of subcarriers corresponds to the backscattered signal, wherein the backscattered signal is a reflection of the first wireless signal from the device that is modulated by N repetitions of K information bits in accordance with a 2^{K}-PSK modulation scheme and the backscattered signal comprises, for each active subcarrier of the plurality of active subcarriers of the first wireless signal, signal components that correspond to subcarriers in the second set of subcarriers that are located at f_{sc}±frequency offset used by the device, where f_{sc} is a center frequency of the active subcarrier and the frequency offset is a multiple of a subcarrier spacing of the first wireless signal.

In one embodiment, demodulating the backscattered signal comprises, for each subcarrier in the second set of subcarriers that correspond to the backscattered signal, applying a first phase and/or amplitude compensation to the subcarrier based on a phase and/or amplitude of a modulation symbol transmitted on a respective active subcarrier of the first wireless signal and applying a second phase compensation to the subcarrier based on a frequency offset between the subcarrier and the respective active subcarrier of the first wireless signal. In one embodiment, demodulating the backscattered signal further comprises performing coherent combining over at least N−1 OFDM symbols over all of the subcarriers in the second set of subcarriers that correspond to the backscattered signal. In one embodiment, demodulating the backscattered signal further comprises, for each subcarrier in the second set of subcarriers that correspond to the backscattered signal, applying an amplitude compensation to the subcarrier based on an amplitude of a modulation symbol transmitted on the respective active subcarrier of the first wireless signal.

In one embodiment, the composite wireless signal is a superposition of the first wireless signal from the transmitter device, the backscattered signal from the device, and a second backscattered signal from a second device, and the method further comprises demodulating the second backscattered signal. In one embodiment, the composite wireless signal further comprises a third set of subcarriers that correspond to the second backscattered signal, wherein the second backscattered signal is a reflection of the first wireless signal from the second device that is modulated by N2 repetitions of K2 information bits in accordance with a 2^{K2}-PSK modulation scheme, wherein N2 may or may not equal N and K2 may or may not equal K, and the second backscattered signal comprises, for each active subcarrier of the plurality of active subcarriers of the first wireless signal, signal components that correspond to subcarriers in the third set of subcarriers that are located at f_{sc}±a second frequency offset used by the second device, where f_{sc} is a center frequency of the active subcarrier and the second frequency offset is a multiple of a subcarrier spacing of the first wireless signal and is different than the frequency offset used by the device. In one embodiment, demodulating the second backscattered signal comprises, for each subcarrier in the third set of subcarriers that correspond to the second backscattered signal, applying a first phase and/or amplitude compensation to the subcarrier based on a phase of a modulation symbol transmitted on a respective active subcarrier of the first wireless signal and applying a second phase compensation to the subcarrier based on a frequency offset between the subcarrier and the respective active subcarrier of the first wireless signal.

In one embodiment, at least one of N, K, and the frequency offset used by the device is predefined or preconfigured.

In one embodiment, the method further comprises receiving, from a control node, information that configures at least one of N, K, and the frequency offset for the device.

In one embodiment, the composite wireless signal comprises the superposition of the first wireless signal from the transmitter device and the backscattered signal from the device in a first sub-band of the composite signal, the backscattered signal being modulated in accordance with a 2^{K}-PSK modulation scheme, and a superposition of the first wireless signal from the transmitter device and a second backscattered signal from a second device in a second sub-band of the composite signal, the second backscattered signal also being modulated in accordance with a 2^{K}-PSK modulation scheme. Further, in one embodiment, demodulating the backscattered signal comprises demodulating the reference signal in the first sub-band, and the method further comprises demodulating the second backscattered signal in the second sub-band. In one embodiment, the first sub-band and the second sub-band are predefined or preconfigured non-overlapping sub-bands. In one embodiment, the method further comprises receiving, from a control node, information that indicates the first sub-band used by the device and the second sub-band used by the second device.

Corresponding embodiments of a receiving device for reception of a backscattered signal from a device where the backscattered signal is modulated using a 2^{K}-PSK modulation scheme are also disclosed.

Embodiments of a method performed by a receiving device for reception of backscattered signals from devices are also disclosed. In one embodiment, the method performed by the receiving node comprises receiving a composite wireless signal, the composite wireless signal being a multi-subcarrier wireless signal. The composite wireless signal comprises, in a first sub-band of a first wireless signal from a transmitter device, a superposition of the first wireless signal from the transmitter device and a first backscattered signal from a first device. The composite wireless signal further comprises, in a second sub-band of the first wireless signal from the transmitter device, a superposition of the first wireless signal from the transmitter device and a second backscattered signal from a second device. The method further comprises demodulating the first backscattered signal from the first device in the first sub-band and demodulating the second backscattered signal from the second device in the second sub-band.

In one embodiment, the first wireless signal comprises a plurality of active subcarriers and at least two inactive subcarriers between each pair of adjacent active subcarriers, the first backscattered signal comprises a plurality of signal components each having a first frequency offset (±Δƒ1) relative to a respective one of the plurality of active subcarriers of the first wireless signal, and the second backscattered signal comprises a plurality of signal components each having a second frequency offset (+Δƒ2) relative to a respective one of the plurality of active subcarriers of the first wireless signal, wherein Δƒ1 may or may not be equal to Δƒ2.

Corresponding embodiments of a receiving device for reception of backscattered signals from devices are also disclosed.

Embodiments of a method performed by a control node are also disclosed. In one embodiment, a method performed by a control node for controlling two or more devices that modulate information or control bits onto backscattered signals generated by reflecting wireless signals transmitted by two or more transmitting devices and for further controlling one or more receiving devices for receiving backscattered signals from the two or more devices comprises sending, to each device of the two or more devices, first information that configures: (a) a frequency offset of subcarriers of the backscattered signal from the device relative to subcarriers of an incident wireless signal at an antenna of the device; (b) a number of information or control bits, K, to be used to modulate the backscattered signal in accordance with a 2^{K}-PSK modulation scheme; (c) a number of repetitions used by the device when modulating the backscattered signal in accordance with a 2^{K}-PSK modulation scheme; or (d) a combination of any two or more of (a)-(c). The method further comprises sending, to a receive device, second information that configures the receive device to receive backscattered signals from the two or more devices.

In one embodiment, for each device of the two or more devices, the second information indicates: (i) a sub-band in which the backscattered signal from the device is to be received; (ii) a frequency offset of subcarriers of the backscattered signal from the device relative to subcarriers of a respective transmit wireless signal; (iii) a number of information or control bits, K, used to modulate the backscattered signal in accordance with a 2^{K}-PSK modulation scheme; (iv) a number of repetitions used by the device when modulating the backscattered signal in accordance with a 2^{K}-PSK modulation scheme; or (v) a combination of any two or more of (i)-(iv).

In one embodiment, the method further comprises sending, to each transmitting device of the two or more transmitting devices, information that configures the transmitting device to transmit a beamformed transmit signal in a direction of one or more particular devices within a particular sub-band of a transmit bandwidth of the transmitting device.

Corresponding embodiments of a control node are also disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a passive transmitter;

FIGS. 2 and 3 illustrate examples of an Orthogonal Frequency Division Multiplexing (OFDM) based impinging, or incident, wireless signal transmitted by a carrier emitter and reflected by a passive transmitter, or backscattering device, where the signal has a comb structure including both active and inactive subcarriers to enable reflected signals to be located at positions of inactive subcarriers to thereby avoid interference at the receiver;

FIG. 4 illustrates an example of a backscattered signal generated based on reflecting the incident wireless signal of FIG. 3;

FIG. 5 illustrates a wireless system in accordance with one example embodiment of the present disclosure;

FIG. 6 illustrates the operation of the wireless system of FIG. 5 to provide backscattering signal transmission and reception using 2^{K}-Phase Shift Keying (PSK) modulation in accordance with some embodiments of the present disclosure;

FIG. 7 is a flow chart that illustrates step 608-1 of FIG. 6 in more detail in accordance with one embodiment of the present disclosure;

FIG. 8 illustrates an example of generation of a backscattered signal using Wideband Binary PSK (WBPSK) modulation in accordance with one embodiment of the present disclosure;

FIG. 9 illustrates one example of Orthogonal Frequency Division Multiple Access (OFDMA) backscattering in accordance with one embodiment of the present disclosure;

FIG. 10 is a frequency-domain representation of one example of a composite signal received by a receive node, where the composite signal includes both the incident wireless signal transmitted by the transmit node, or carrier emitter, and a backscattered signal emitted by a backscattering device based on reflecting the incident wireless signal;

FIG. 11 is a flow chart that illustrates the operation of the receiver node of FIG. 5 and more specifically illustrates an example embodiment of steps 610 and 612-1 (or likewise step 612-2) of FIG. 6, in accordance with one embodiment of the present disclosure;

FIG. 12 illustrates simulation results for one example implementation of an example embodiment of the present disclosure;

FIG. 13 illustrates one example of OFDMA backscattering in accordance with an embodiment of the present disclosure;

FIG. 14 illustrates a transmit node, or carrier emitter, that transmits wireless signals in different frequency subbands using different beams, in accordance with an embodiment of the present disclosure;

FIG. 15 is a frequency-domain representation of an OFDM based wireless signal transmitted by a transmit node using different beams in different subbands as well as frequency locations of reflected signals from different backscattering devices in response to parts of the wireless signal in the different subbands, in accordance with one embodiment of the present disclosure;

FIG. 16 is a frequency-domain representation of two OFDM based wireless signals transmitted by two transmit nodes using different beams in different subbands as well as frequency locations of reflected signals from different backscattering devices in response to the wireless signals in the different subbands, in accordance with one embodiment of the present disclosure;

FIG. 17 is a frequency-domain representation of an embodiment that utilizes both OFDMA backscattering and beams/subbands, in accordance with another embodiment of the present disclosure;

FIG. 18 illustrates the operation of the wireless system of FIG. 6 to enable subband/beam backscattering, potentially along with OFDMA backscattering, in accordance with an example embodiment of the present disclosure;

FIGS. 19 and 20 illustrate two examples of a wireless system in which various multiple access features can be used in accordance with embodiments of the present disclosure;

FIG. 21 illustrates one example embodiment of backscattering with subband/beam based multiple access in accordance with an embodiment of the present disclosure;

FIG. 22 illustrates one example embodiment of backscattering with subband/beam based multiple access combined with OFDMA backscattering in accordance with another embodiment of the present disclosure;

FIG. 23 illustrates the operation of the wireless systems of FIGS. 19 and 20 in accordance with an embodiment of the present disclosure;

FIG. 24 is a schematic block diagram of a wireless device according to some embodiments of the present disclosure; and

FIG. 25 is a schematic block diagram of the wireless device of FIG. 24 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Wireless Device: As used herein, a “wireless device” is a device that wirelessly transmits and/or receives a wireless signal (e.g., a Radio Frequency (RF) signal or millimeter wave (mmW) signal). One example of a wireless device is an Internet of Things (IoT) device. Such wireless devices may be, or may be integrated into, a sensor device, a meter, a device in an automated environment (e.g., container moving within an automated warehouse or factory), any type of consumer electronic device (e.g., a television, refrigerator, smartphone, tablet computer, etc.), or the like. A wireless device may be a portable, hand-held, computer-comprised, or vehicle-mounted mobile device, enabled to communicate information (e.g., data) via a wireless signal.

Backscattering Device: As used herein, a “backscattering device” or “backscattering transmitter” is one type of wireless device that transmits a signal by backscattering an incident wireless signal at an antenna of the device.

Passive Device: As used herein, a “passive device” or “passive transmitter” is one type of backscattering device that is powered entirely by the energy received from incident wireless signal received at the device's antenna.

Semi-Passive Device: As used herein, a “semi-passive device” or “semi-passive transmitter” is one type of backscattering device that has a battery or some form of energy storage (e.g., a super-cap) that can be charged, e.g., from ambient sources (e.g., light, vibrations) different from the incident wireless signal received at the antenna and consumes power to perform baseband processing but lacks a power amplifier and many other components present in a conventional radio frequency (RF) transmitter chain.

Systems and methods are disclosed herein related to backscattering devices. A number of embodiments are described below under separate headings; however, it is to be understood that the embodiments described under the different headings below may be used independently from one another or in any desired combination.

### Backscattering Signal Transmission and Reception Using Wideband 2^{K}-PSK Modulation

Before describing embodiments of the present disclosure, it is important to note that the '775 Patent disclosed a technique to modulate data onto a reflected, or backscattered, signal using On-Off Keying (OOK) or Frequency Shift Keying (FSK). One problem is that these modulation techniques are not spectrally efficient. Spectral efficiency is desirable, especially if the backscattering devices are deployed in licensed spectrum.

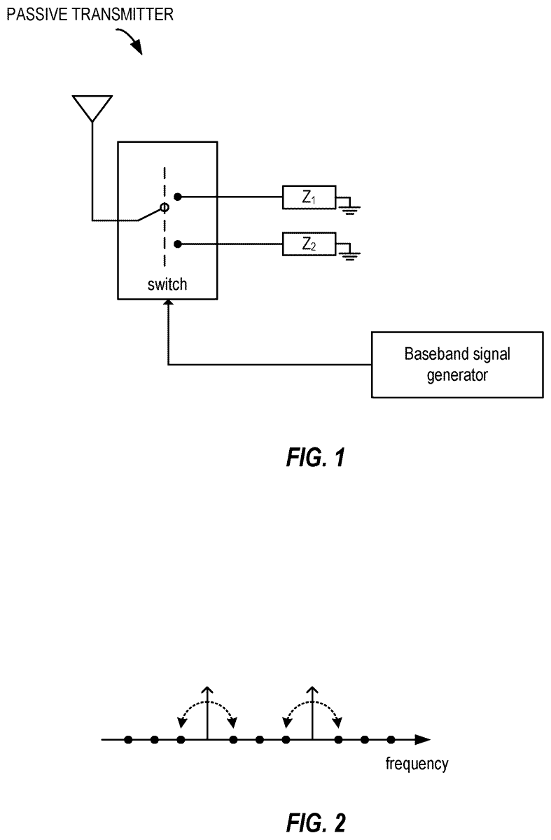

Systems and methods are disclosed herein that address the aforementioned and/or other challenges with existing backscattering device technology. In this regard, embodiments are disclosed that enable a backscattering device to transmit a wireless signal using a 2^{K}-Phase Shift Keying (PSK) modulation technique, where K is a number of information or code bits conveyed by each modulation symbol. In one embodiment, the backscattering device has an architecture such as that of FIG. 1, and switching patterns for switching between the two impedances at the antenna of the device are chosen according to a defined codebook for 2^{K}-PSK modulation. In addition, a switching rate for switching between the two impedances in accordance with the desired code is selected as a multiple of a subcarrier spacing of the incident wireless signal (i.e., switching rate=R×subcarrier spacing, where R is a positive integer that is greater than or equal to 1). For example, for 4-PSK (i.e., Quadrature PSK (QPSK)), the codebook corresponding to the four constellation points in the QPSK constellation could be defined as {0011,0110,1100,1001}, where a ‘0’ means that the antenna is connected to impedance Z1 and a ‘1’ that the antenna is connected to the impedance Z2 (or vice versa). No requirement is imposed on the impedances Z1, Z2 except that they must be different.

Embodiments of the present disclosure may provide a number of advantages over existing backscattering technology. Embodiments of the present disclosure enable the generation of 2^{K}-PSK signals (2^{K}-PSK or Binary Phase Shift Keying (BPSK) signals, 4-PSK or QPSK signals, 8-PSK signals, etc.) that are orthogonal in the frequency domain to, e.g., the incident wireless signal at the antenna and, in some embodiments, other wireless signals transmitted by other nearby backscattering devices, thus enabling both suppression of self-interference and Orthogonal Frequency Division Multiple Access (OFDMA). These 2^{K}-PSK modulations are more spectrally efficient than FSK and OOK and can be generated with any backscattering device (even those supporting only OOK: first antenna impedance to reflect incoming RF waves, second antenna impedance to absorb incoming RF waves). When enabling multiple access, the switching rates used are of the order of, e.g., a few times the subcarrier spacing. For example, if the subcarrier spacing is 15 kilohertz (kHz), then a switching rate of 60 kHz is enough to generate orthogonal QPSK signals. Moreover, near-orthogonality in the frequency domain can be obtained even if the oscillator in the backscattering device is highly inaccurate, with frequency errors up to thousands of parts per million.

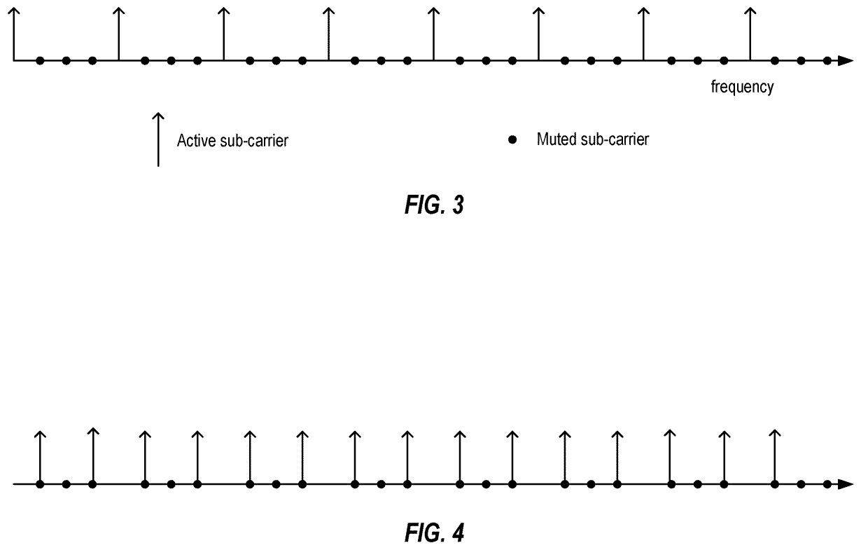

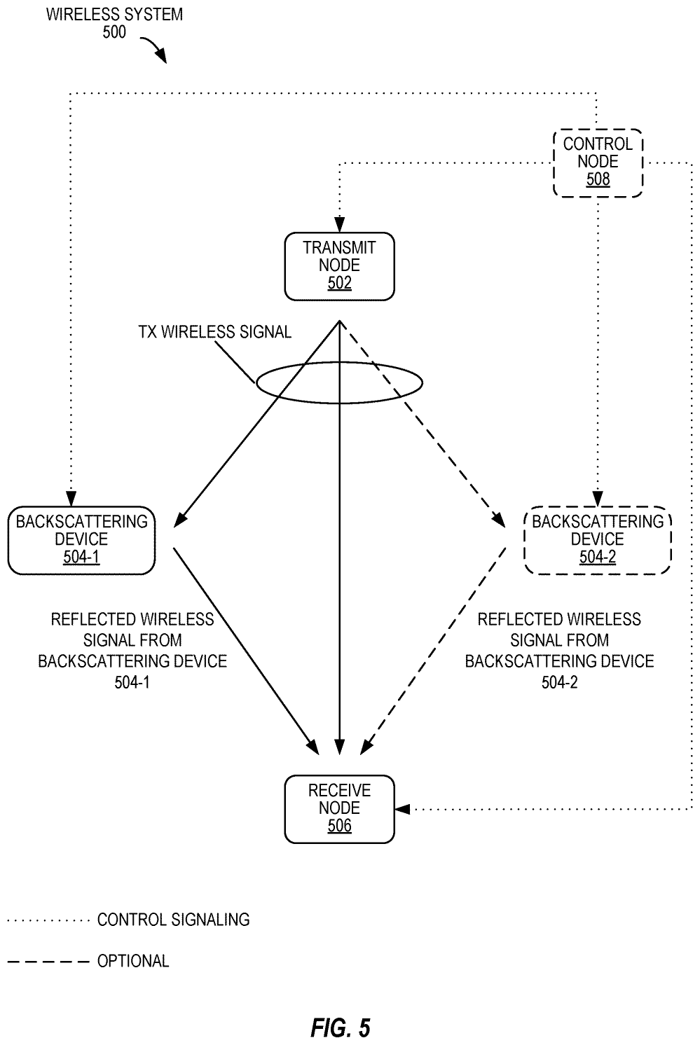

In this regard, FIG. 5 illustrates a wireless system 500 in accordance with one example embodiment of the present disclosure. Optional elements are represented by dashed boxes. As illustrated, the wireless system 500 includes a transmit node 502, one or more backscattering devices including backscattering device 504-1 and optionally backscattering device 504-2, a receive node 506, and optionally a control node 508. As described below in detail, the transmit node 502 transmits a wireless signal, where this wireless signal includes multiple subcarriers arranged in a comb structure. More specifically, the wireless signal is a multi-subcarrier signal (e.g., Orthogonal Frequency Division Multiplexing (OFDM) signal) having a subcarrier spacing (Δƒ) but where only some of the subcarriers are active. For at least some, but preferably all, pairs of adjacent active subcarriers, at least two inactive subcarriers are located between the pairs of adjacent active subcarriers (see, e.g., FIG. 3).

At the backscattering device 504-1, while the wireless signal (also referred to herein as the “incident wireless signal”) from the transmit node 502 is present at an antenna of the backscatter device 504-1, the backscattering device 504-1 generates a backscattered signal that is modulated in accordance with a 2^{K}-PSK modulation scheme and has frequency components frequency-aligned with at least some of the inactive subcarriers of the incident wireless signal. This backscattered signal is emitted from the antenna of the backscattering device 504-1.

In some embodiments, a second backscattering device 504-2 operates concurrently with the first backscattering device 504-1 in accordance with a multiple access scheme. More specifically, while the wireless signal (also referred to herein as the “incident wireless signal”) from the transmit node 502 is present at an antenna of the backscatter device 504-2, the backscattering device 504-2 generates a backscattered signal that is modulated in accordance with a 2^{K}-PSK modulation scheme and has frequency components frequency-aligned with at least some of the inactive subcarriers of the incident wireless signal. This backscattered signal is emitted from the antenna of the backscattering device 504-2. For the multiple access scheme, the backscattered signal generated and emitted by the backscattering device 504-1 has frequency components that are frequency-aligned with a first subset of the inactive subcarriers of the incident wireless signal, and the backscattered signal generated and emitted by the backscattering device 504-2 has frequency components that are frequency-aligned with a second subset of the inactive subcarriers of the incident wireless signal, where the first and second subsets of the inactive subcarriers of the incident wireless signal are disjoint subsets (i.e., have no element in common).

The receiver node 506 receives the backscattered signal from the backscattering device 504-1, optionally receives the wireless signal transmitted by the transit node 502, and, if present, receives the backscattered signal from the backscattering device 504-2.

In some embodiments, the control node 508 controls as least some aspects of the operation of the backscattering devices 504-1, 504-2 and/or at least some aspects of the operation of the receiver node 506, as described below in detail.

In one embodiment, transmit node 502 (also referred to herein as a “carrier emitter”) transmits an Orthogonal Frequency Division Multiplexing (OFDM) signal having a comb pattern, which means that there are inactive subcarriers between any pair of active subcarriers, as illustrated in the example of FIG. 3. Suppose that the OFDM symbol duration, excluding the Cyclic Prefix (CP), is T_{OFDM} [s]. Furthermore, assume that backscattering devices 504-1, 504-2 each can switch (i.e,. change the switch position) at a rate exceeding 1/T_{OFDM}.

The backscattering device 504-1 (and likewise the backscattering device 504-2 if present) has an architecture such as that illustrated in FIG. 1 where the backscattering device 504-1 includes an antenna selectively coupled to two different impedances (Z₁ and Z₂) via a switch. The backscattering device 504-1 utilizes a switching period that is equal to

$$\frac{{T}_{O F D M}}{2 M} ,$$

where M is a positive integer larger than or switching period that is equal to equal to 1. This means that, for each (information or code) bit in a baseband signal used to control the switch, the switch remains in a fixed position for a time

$$\frac{{T}_{O F D M}}{2 M}$$

and then changes position or remains in the same position according to the value of the next bit in the baseband signal. M is used to control the frequency shift of the backscattered signal with respect to the impinging signal. The device repeats a pattern from a codebook N times, where N is also a positive integer. N is used to obtain a processing gain and be able to handle large timing errors in the device. In one embodiment, the values of M, N are pre-programmed in the backscattering device 504-1. In another embodiment, the control node 508 signals, to the backscattering device 504-1, the value of M and/or the value of N. In another embodiment, the control node 508 signals, to the backscattering device 504-1, the integer values M, N and a starting time for its transmission. This starting time could be given in terms of, e.g., the number of clock ticks until the backscatter device 504-1 is allowed to start transmitting.

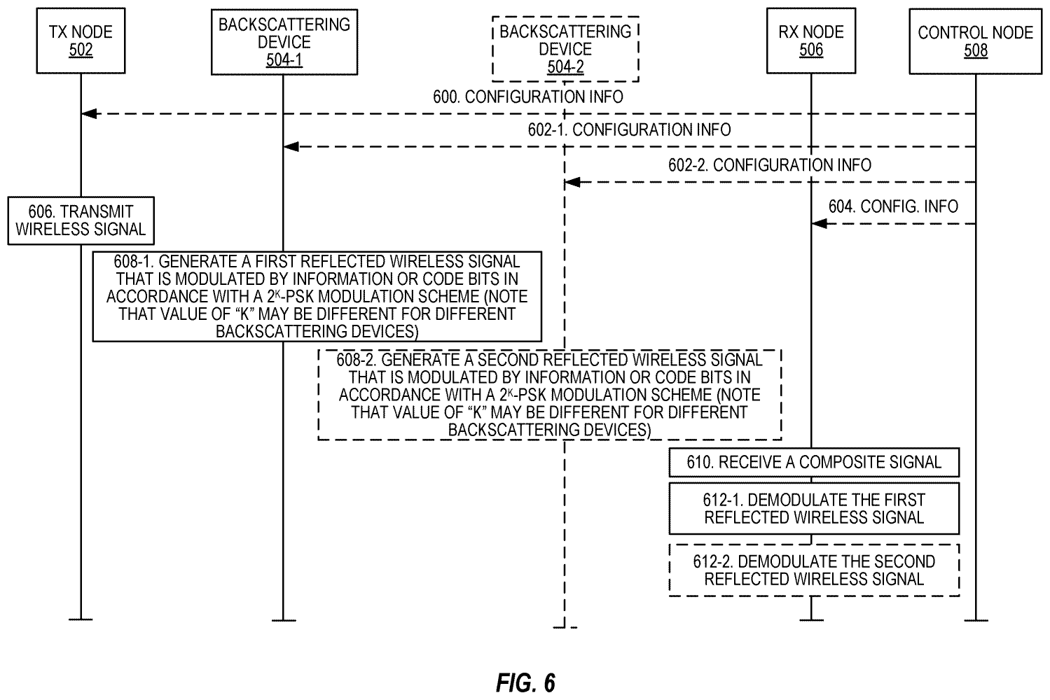

FIG. 6 illustrates the operation of the wireless system 500 of FIG. 5 in accordance with embodiments of the present disclosure. Optional elements/steps are represented by dashed lines or boxes. As illustrated, in one embodiment, the control node 508 configures the transmit node 502, the backscattering devices 504-1 and 504-2, and/or the receive node 506 with one or more parameters for enabling the 2^{K}-PSK backscattering transmission/reception and/or multiple access operation as described herein (steps 600, 602-1, 602-2, and 604). For example, the control node 508 may configure the backscattering devices 504-1 and 504-2 with one or more parameters such as, e.g., respective values of M, N, and/or starting time for backscattered signal transmission.

The transmit node 502 transmits a wireless signal, where the wireless signal is a multi-subcarrier signal (e.g., OFDM signal in the example embodiments described herein) having both active subcarriers and inactive subcarriers in a comb arrangement where two or more inactive subcarriers are between some, but preferably all, pairs of adjacent active subcarriers (step 606). The OFDM symbol duration, excluding the CP, is T_{OFDM} [s]. Each of the backscattering devices 504-1, 504-2 is able to switch at a rate faster than 1/T_{OFDM}.

While the wireless signal (i.e., incident signal) is present at the antenna of the backscattering device 504-1, the backscattering device 504-1 generates a backscattered signal that is modulated by information or code bits in accordance with a 2^{K}-PSK modulation scheme (step 608-1). Likewise, while the wireless signal (i.e., incident signal) is present at the antenna of the backscattering device 504-2, the backscattering device 504-2 generates a backscattered signal that is modulated by information or code bits in accordance with a 2^{K}-PSK modulation scheme (step 608-2). Note that the “K” is, at least in some embodiments, specific to each backscattering device 504 (i.e., different backscattering devices 504 may use (e.g., be configured with) different values of “K”). Further details of steps 608-1 and 608-2 are provided below.

At the receive node 506, the receive node 506 receives a composite signal that includes the signal transmitted by the transmit node 502, the backscattered signal from the backscattering device 504-1, and, if present, the backscattered signal from the backscattering device 504-2 (step 610). Assuming that backscattered signals from both the backscattered device 504-1 and the backscattering device 504-2 are present, then the composite signal includes a first set of subcarriers that correspond to the active subcarriers of wireless signal transmitted by the transmit node 502, a second set of subcarriers that correspond to the backscattered signal from the backscattering device 504-1, and a third set of subcarriers that correspond to the backscattered signal from the backscattering device 504-2, where the first, second, and third sets of subcarriers are disjoint subsets (i.e., have no element/subcarrier in common). Because the signals are orthogonal, the receive node 506 is able to separate the signals in the frequency domain. The receive node 506 demodulates the backscattered signal from the backscattering device 504-1 (step 612-1) and, if present, demodulates the backscattered signal from the backscattering device 504-2 (step 612-2). Further details regarding the operation of the receive node 506 are provided below.

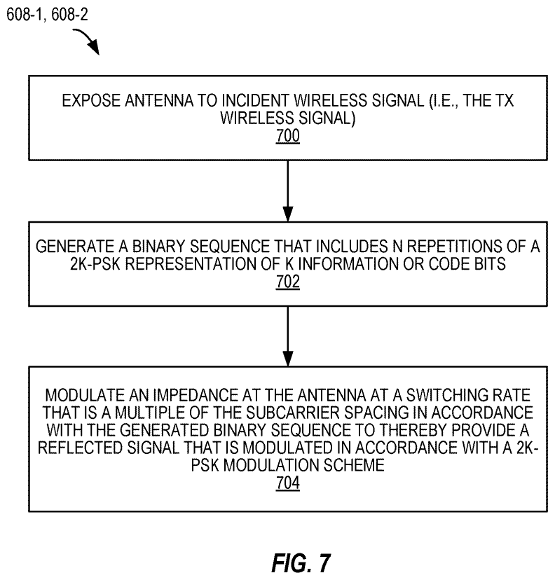

FIG. 7 is a flow chart that illustrates step 608-1 of FIG. 6 in more detail in accordance with one embodiment of the present disclosure. Note that this discussion is equally applicable to step 608-2 for the backscattering device 504-2. As illustrated, the backscattering device 504-1 exposes an antenna of the backscattering device 504-1 to the incident wireless signal (i.e., the wireless signal transmitted by the transmit node 502 in step 606) (step 700). While exposing the antenna to the incident signal, the backscattering device 504-1 generates a binary sequence that includes N repetitions of a 2^{K}-PSK representation of K information or code bits (i.e., N repetitions of a 2^{K}-PSK modulation symbol corresponding to K information or code bits) (step 702). More specifically, the 2^{K}-PSK representation of the K information or code bits comprises one of 2^{K} cyclic shifts of a base sequence of 2^{K-1} zeros followed by 2^{K-1} ones that is mapped to a particular binary sequence formed by the K information or code bits, wherein K is a positive integer value that is greater than or equal to 1 and N is a positive integer value that is greater than or equal to 1. Mappings between different binary sequences of K information or code bits and the 2^{K} cyclic shifts of the base sequence are predefined or preconfigured. The backscattering device 504-1 then modulates an impedance of at the antenna of the backscattering device 504-1 between two different impedances (one corresponding to a binary ‘0’ and the other corresponding to a binary ‘1’) at a switching rate that is a multiple of the subcarrier spacing of the incident signal in accordance with the generated binary sequence to thereby provide the backscattered signal that is modulated in accordance with the 2^{K}-PSK modulation scheme (step 704). Note that the switching rate may be 2*M times the subcarrier spacing of the incident signal, where M is a positive integer that is greater than or equal to 1.

In one example embodiment, the backscattering device 504-1 generates BPSK by backscattering a wideband signal, a modulation referred to herein as wideband BPSK (WBPSK) or wideband 2^{K}-PSK. In this regard, using the architecture of FIG. 1 as an example, for a first point in the BPSK constellation, the backscattering device 504-1 generates, in step 702, a baseband signal consisting of the pattern 01 repeated N times. When applied to switch the impedance at the antenna between the two different impedances at the switching frequency of (2*M)·Δƒ in step 704, this baseband signal translates, in frequency, the each of the active subcarriers of the impinging signal by ±(M)·Δƒ, where Δƒ=1/T_{OFDM} is the subcarrier spacing of the impinging signal, thereby creating the backscattered signal emitted from the antenna that represents N repetitions of the transmitted BPSK symbol for the second point in the BPSK constellation. Likewise, for a second point in the BPSK constellation, the backscattering device 504-1 generates, in step 702, a baseband signal consisting of the pattern 10 repeated N times. When applied to switch the impedance at the antenna between the two different impedances at the switching frequency of (2*M)·Δƒ in step 704, this baseband signal translates, in frequency, each of the active subcarriers of the impinging signal by ±(M)·Δƒ, where Δƒ=1/T_{OFDM} is the subcarrier spacing of the impinging signal, thereby creating the backscattered signal emitted from the antenna that represents the N repetitions of the BPSK symbol for the second point in the BPSK constellation. In this way, the backscattering device 504-1 can generate a sequence of BPSK symbols.

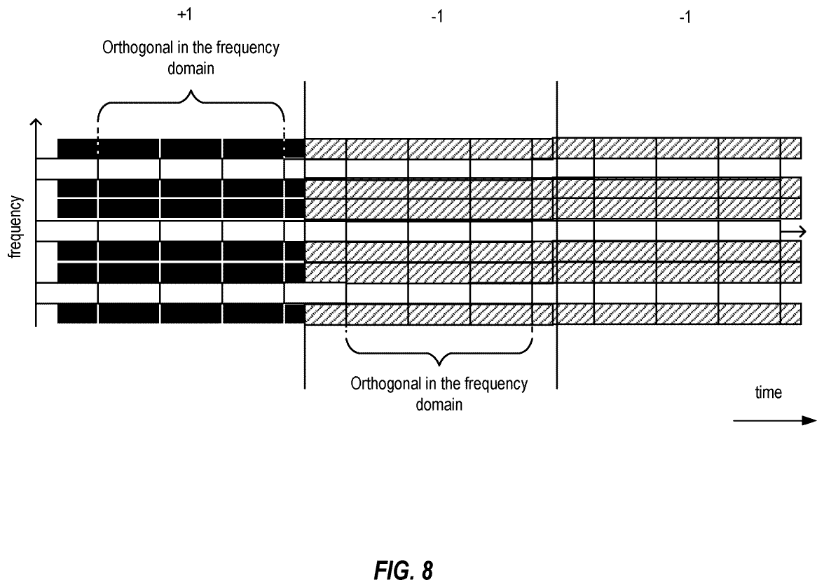

FIG. 8 illustrates an example of generation of WBPSK with M=1, N=4. The black rectangles are a frequency domain representation of the backscattered signal obtained by using switching according to the pattern 01010101, while the diagonal patterned rectangles correspond to switching according to the pattern 10101010. The white rectangles represent the impinging OFDM signal.

Note that, since the resolution of the clock of the backscattering device 504-1 is generally too low, the starting point of each symbol may not be aligned with the OFDM grid of the incoming signal (not even to within the cyclic prefix). For that reason, the use of N repetitions where N>1 is beneficial. In this way, the receiver node 506 will experience N−1 orthogonal OFDM symbols in each sequence of N consecutive OFDM symbols, as illustrated in FIG. 8. Also, repetition gives a processing gain of 10*log10(N), which is useful since the backscattered signals are often very weak.

The generation of QPSK and higher order PSK signals is an extension of the embodiment described above for BPSK. These modulations can more generally be referred to herein as wideband 2^{K}-PSK modulations. In this regard, suppose that the switching rate is 2^{K}·M/T_{OFDM}. A baseband signal (generated in step 702) consisting of the pattern 0 . . . 01 . . . 1 comprising 2^{K-1} zeros followed by 2^{K-1} ones and repeated N times will translate, in frequency, the impinging signal by M·Δƒ, where Δƒ=1/T_{OFDM} is the subcarrier spacing. There are exactly 2^{K} different bit patterns obtained from 0 . . . 01 . . . 1 by circular shifts. For example, for K=2, N=1, there are 4 patterns 0011, 1001, 1100, 0110 that can be obtained by circularly shifting the pattern 0011. These 2^{K} generate 2^{K} equally spaced phase shifts, hence they can be used to generate 2^{K}-PSK signals. The role of the repetition factor N is the same as for BPSK: to give a processing gain and to help ensure that there is orthogonality in the frequency domain even if the timing offsets exceed the cyclic prefix.

Using the techniques explained above, it is possible to create a codebook with 2^{K} bit patterns that generate as many different signals, whose phases are uniformly spaced in the unit circle. Thus, the backscattering device 504-1 (and likewise the backscattering device 504-2) can map K bits to each entry in the codebook.

In one embodiment, multiple access to the wireless medium by multiple backscattering devices (e.g., backscattering devices 504-1 and 504-2) is enabled. This is referred to herein as OFDMA backscattering. While further details of OFDMA backscattering are provided below, in one embodiment, each backscattering device 504-p (where p=1 or 2 in the example of FIG. 5) is assigned a pair of integers (Mₚ, Nₚ). While the value of Nₚ could be the same for all of the backscattering devices 504-p, to preserve orthogonality in the frequency domain, the values Mₚ must be different for different backscattering devices 504-p. In these conditions, two or more backscattering devices (e.g., backscattering devices 504-1 and 504-2) are allowed simultaneous access to the wireless medium, and the receiver node 506 can separate the respective backscattered signals in the frequency domain as they would be using orthogonal subcarriers. Note that Kₚ is used herein to refer to the “K” value for the p-th backscattering device 504-p.

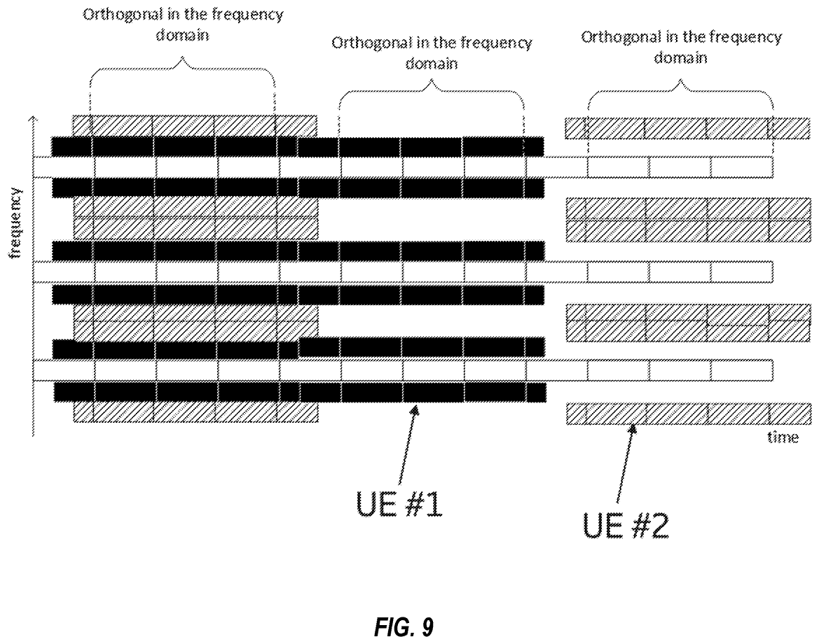

One example of OFDMA backscattering is illustrated in FIG. 9. In this example, for the backscattering device 504-1, M₁=1 and N₁=4. For the backscattering device 504-2, M₂=2 and N₂=4. The black rectangles in FIG. 9 are used to depict the backscattered signal from the backscattering device 504-1, and the hashed rectangles depict the backscattered signal from the backscattering device 504-2. The white rectangles depict the impinging signal. In this example, the number of inactive subcarriers between a pair of active OFDM subcarriers in the imping signal needs to be at least 2*number of backscattering devices.

Embodiments related to the operation of the receiver node 506 to receive the backscattered signal(s) from the backscattering device(s) 504-1 (and optionally 504-2) that are modulated in accordance with a 2^{K}-PSK modulation scheme will now be described. These embodiments are relevant to steps 610, 612-1 and 612-2 of FIG. 6. Embodiments disclosed herein enable coherent reception of the backscattered signal(s), thus increasing the reception sensitivity and spectral efficiency. The embodiments disclosed herein may also enable data communication between the transmit node 502 (i.e., the carrier emitter) and the receive node 506 (i.e., receiver/reader). Furthermore, baseband signal processing at the receive node 506 is done in the frequency domain which enables reuse of e.g., the existing 4G/5G signal processing hardware and software. Embodiments of the present disclosure may enable the use of advanced multiple access like Multi-User Multiple-Input Multiple-Output (MU-MIMO) and OFDMA commonly used in 4G/5G to multiplex low complexity backscattering devices.

As described above, the transmit node 502 transmits an OFDM signal having a comb pattern in the frequency domain with subcarrier spacing Δƒ. The active subcarriers of the transmitted OFDM signal are allocated as a comb pattern, and there are at least two or more inactive, or null, subcarriers between each pair of adjacent active subcarriers. The backscattered signal from the backscattering device 504-1 (and likewise that from the backscattering device 504-2 if present) includes subcarriers, or frequency components, located in the frequency domain at ±(M)·Δƒ around the center of frequency of the respective active subcarriers of the OFDM signal transmitted by the transmit node 502. These are the subcarriers corresponding to the backscattered signal. Thus, in this example, each OFDM modulation symbol in an active subcarrier is reflected to two neighboring subcarriers with its modulation symbol. Let's call these reflected subcarriers. For each pair of OFDM active subcarriers, at least two inactive subcarriers need to be reserved between them. With OFDMA backscattering where multiple backscatter devices are ‘carried’ by one carrier emitter orthogonally, the number of inactive subcarriers between two adjacent active subcarriers is 2*number of backscatter devices.

The transmit node 502, which can be a base station (e.g., an evolved Node B (eNB) or next-generation Node B (gNB)) or a Fifth Generation (5G) or 6th Generation (6G) User Equipment (UE), transmits a wireless signal. In one embodiment, some OFDM pilots or reference signals in the wireless signal transmitted by the transmit node 502 can be allocated (e.g., by the control node 508) according to a predefined pattern only in some of the active subcarriers in the frequency domain and/or only in some of the OFDM time domain symbols. This enables active subcarriers and/or OFDM time domain symbols that are not used by the OFDM pilots or reference signals to be used to transmit data to the receiver node 506 via a direct link from the transmit node 502 to the receive node 506. In another embodiment, when no data is to be transmitted from the transmit node 502 to the receive node 506, pilots can be transmitted in all active subcarriers. In yet another embodiment, differentially modulated symbols are transmitted in all active subcarriers.

The backscatter device 504-p(where p=1 or 2 in the example of FIG. 5) transmits a backscattered signal by reflecting the wireless signal (i.e., the incident signal) as described above. To estimate the timing, frequency offset, and the fading channel for coherent detection, in one embodiment, some of the bits transmitted in the backscattered sigil are pilots according to a predefined, configured, or selected pattern. Other parameters that can be predefined or configured (e.g., by the control node) include Kₚ, Mₚ and Nₚ.

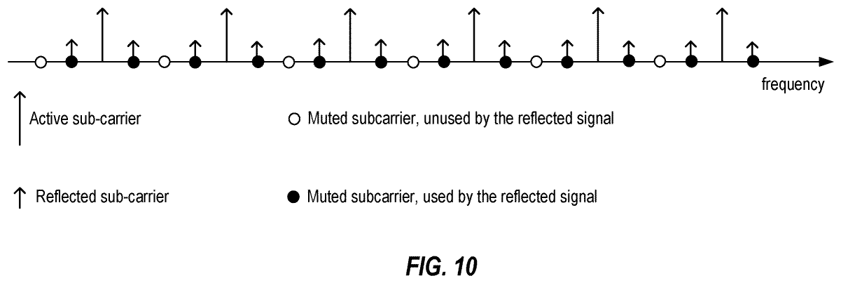

The receiver node 506, which can be a base station or a UE, receives a composite signal, which is the superposition of the wireless signal transmitted by the transmit node 502 and the backscattered signal(s) from the backscattering device(s) 504-p, as illustrated in FIG. 10. In FIG. 10, the taller arrows illustrate the active subcarriers of the wireless signal transmitted by the transmit node 502 and the shorter arrows illustrate the subcarriers of one backscattered signal (e.g., a backscattered signal from the backscattering device 504-1).

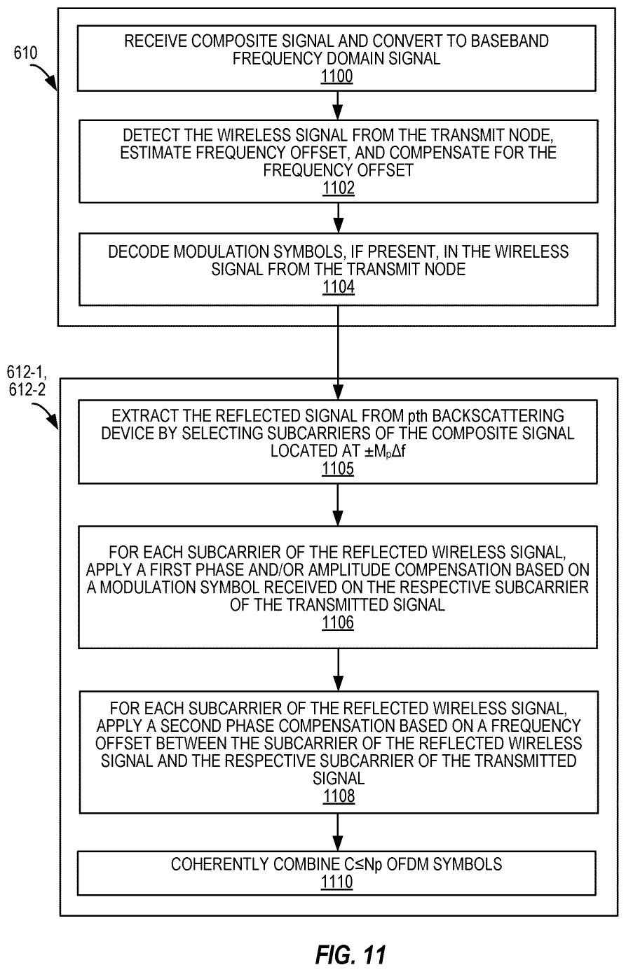

FIG. 11 illustrates the operation of the receiver node 506 in accordance with one embodiment of the present disclosure. In particular, FIG. 11 illustrate steps 610 and 612-1 (or likewise step 612-2) of FIG. 6 in more detail, in accordance with one embodiment of the present disclosure. As illustrated, the receive node 606 receives the composite signal and converts the composite signal to a baseband frequency domain signal (step 1100). As discussed above, the composite signal is the superposition of the wireless signal transmitted by the transmit node 502, the backscattered signal from the backscattering device 504-1, and, if present, the backscattered signal(s) from one or more additional backscattering devices (e.g., the backscattering device 504-2). The receive node 506 then processes the baseband frequency domain signal to detect the wireless signal from the transmit node 502, estimate a frequency offset of the wireless signal from the transmit node 502, and compensate for the frequency offset of the wireless signal (step 1102). The receive node then further processes the frequency-compensated wireless signal (i.e., the frequency-compensated baseband frequency-domain representation of the wireless signal) to decode modulation symbols, if present, in each of the active subcarriers of the wireless signal (step 1104).

Next, in order to decode the backscattered signal from the backscattering device 504-1, the receive node 506 detects, or extracts, the backscattered signal (i.e., a baseband frequency domain representation of the backscattered signal) from the baseband frequency domain signal by selecting the subcarriers of the composite signal that are located at ±(M₁)·Δƒ around the active subcarriers of the wireless signal transmitted by the transmit node 502 (step 1105). Then, for each subcarrier of the backscattered signal, applies a first phase and/or amplitude compensation and optionally an amplitude compensation based on the modulation symbol (if any) received on the respective active subcarrier of the wireless signal transmitted by the transmit node 502 (and detected in step 1104) (step 1106). In other words, the modulation symbol has an amplitude and/or a phase, depending on the type of modulation used. Thus, the compensation applied in step 1106 can compensate for the amplitude of the modulation symbol, the phase of the modulation, or both the amplitude and the phase of the modulation symbol. The phase and amplitude compensation are the inverse of the amplitude and phase of the modulation symbol received on the respective active subcarrier of the wireless signal transmitted by the transmit node 502. In addition, for each subcarrier of the backscattered signal, the receive node 506 applies a second phase compensation based on a frequency offset between the subcarrier of the backscattered signal and the respective active subcarrier of the wireless signal transmitted by the transmit node 502 (step 1108). The receive node 506 then determines a number C of OFDM symbols to be coherently combined and combines the C OFDM symbols over all subcarriers that correspond to the subcarriers of the backscattered signal (step 1110).

Two or more backscatter devices can be orthogonally multiplexed in the frequency domain by assigning a user-specific frequency shift to each device. Due to the orthogonality in the frequency domain, the processing for each device is identical to the single backscattering device case.

Simulations have been performed in All White Gaussian Noise (AWGN) and fading channels, using the following settings.
Subcarrier spacing of 15 kHz
Device oscillator frequency error: 1000 parts per million
Impinging signal is an OFDM signal with 3.84 MHz bandwidth and has a frequency domain comb pattern where only every 5-th subcarrier is active
No channel coding
36 bit payload
M=1, N=4, K=2 (QPSK)

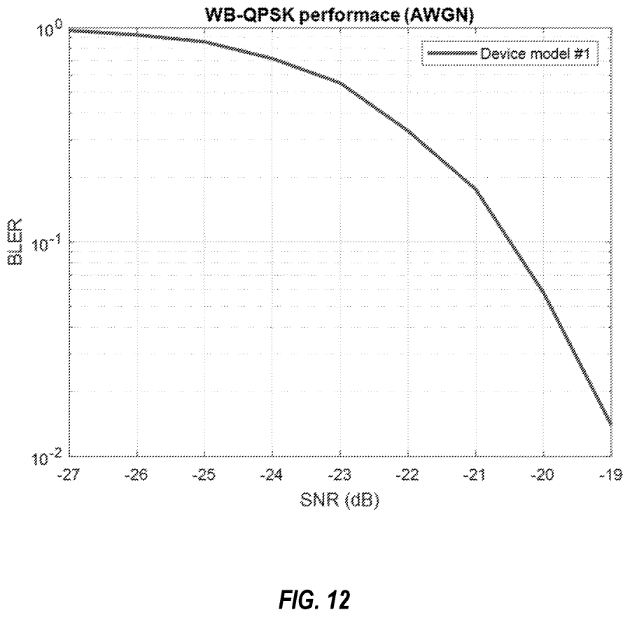

The simulation results for AWGN are shown in FIG. 12. As can be seen from the simulation results, with this modulation, a backscattering device can operate at very low Signal to Noise Ratio (SNR) due to the large processing gains from the repetitions in time and frequency domain.

### Frequency Usage for Backscattering Signal Carried by Comb OFDM Signal

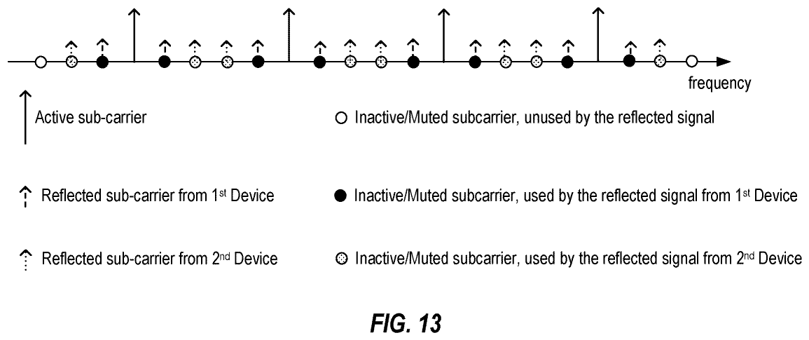

Embodiments of the present disclosure described above enable the generation of 2^{K}-PSK modulated backscattered signals that are orthogonal in the frequency domain, thus enabling both OFDMA and suppression of the direct link interference at the receiver node 506. Regarding OFDMA backscattering, embodiments described above enable different backscattering devices (e.g., backscattering devices 504-1 and 504-2) to reflect to certain given muted-subcarriers as illustrated in FIG. 13. In the example of FIG. 13, one backscattering device (e.g., backscattering device 504-1) reflects to a first subset of the inactive subcarriers indicated by the black dots, and another backscattering device (e.g., backscattering device 504-2) reflects to a second subset of the inactive subcarriers indicated by the dots with a dotted pattern fill. As shown, the first and second subsets of the inactive subcarriers are disjoint subsets (i.e., they have no subcarrier in common).

A problem with backscattering devices is that such low complexity devices often lack filters or other means to control the bandwidth of the backscattered signal. Backscatter devices can shift the backscattered signal in frequency and enable frequency division multiplexing, but that requires an increase in the frequency of the local oscillators, which in turn increases the power consumption and complexity.

Systems and methods are disclosed herein in which multiple backscattering devices can be multiplexed, in the frequency domain, to different frequency subbands with beamforming techniques with one or multiple target receiver nodes. In one embodiment, the transmitter node generates different beams that use different frequency subbands, where the different beams are directed to different backscattering devices. Moreover, this technique can be combined with OFDMA to enable multiplexing of more backscatter devices.

Embodiments of the present disclosure may enable flexible use of frequency spectrum and increase spectral efficiency without requiring an increase of the frequency of the local oscillators of the backscattering devices.

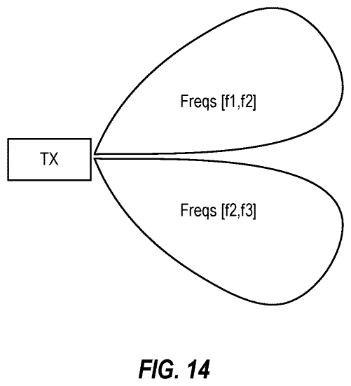

In one embodiment, the transmit node 502 has an antenna array and can synthesize, or generate, different beams to transmit signals in different frequency ranges or subbands. This can be combined with subcarrier orthogonal frequency multiple access (OFDMA, cf. FIG. 13), i.e. performing orthogonal access within each beam, as illustrated in FIG. 14.

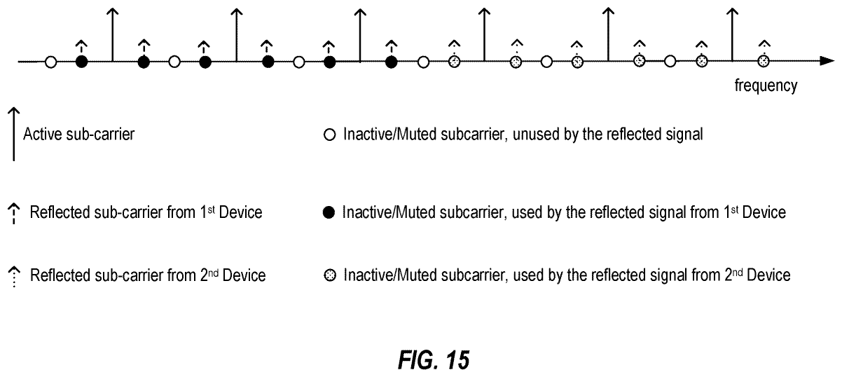

In one embodiment, the transmit node 502 transmits an OFDM signal having a comb pattern with bandwidth W, precoded so that multiple backscattering devices 504-p can reflect different subbands, as illustrated in FIG. 15 for two backscattering devices operating in two subbands. In FIG. 15, the black dots illustrate the reflection of one backscattering device (e.g., backscattering device 504-1) in one beam used in one subband, and the dots with the dotted pattern fill illustrate the reflection of another backscattering device (e.g., backscattering device 504-2) in another beam used in another subband.

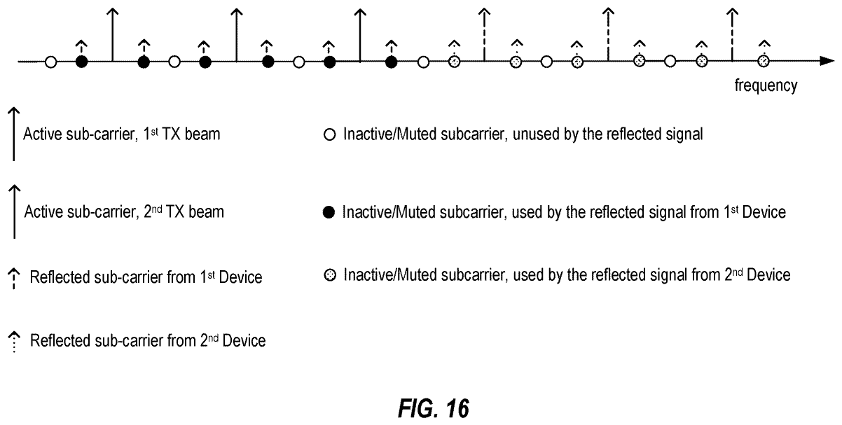

In another embodiment, the transmit node 502 transmits e.g., two precoded OFDM signals in two different subbands (and, e.g., using different beams), where two backscattering devices reflect different subbands and have two different target receive nodes, as illustrated in FIG. 16. In this embodiment, the transmit node 502 transmits two different impinging signals in different subbands for different backscattering devices. In FIG. 16, the black dots illustrate the reflection from one backscattering device for one reflected signal directed to one receive node, and the dots with the dotted pattern fill illustrate the reflection of another backscattering device for the other reflected signal directed to the same or different receive node. It can also be the case that two backscattering devices reflect signals from different carrier emitters. In this case, a certain degree of frequency and time synchronization between the carrier emitters is needed in order to avoid interference when using sub-band transmissions.

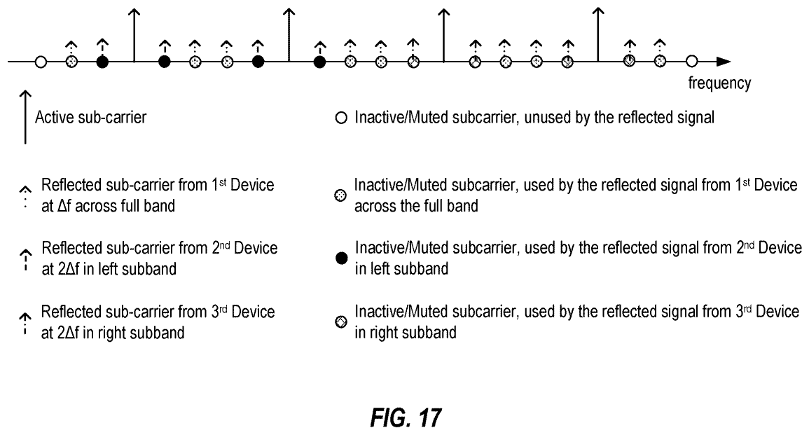

Yet another embodiment is a combination of subcarrier OFDMA and subband OFDMA with precoding/MIMO technique as illustrated in FIG. 17. In this example of FIG. 17, one of the backscatter devices reflects with 2Δƒ (to the sub-carriers marked with the dots with the dotted pattern fill), the other one reflects with Δƒ in the left subband (to the subcarriers marked with black dots), and the third one reflects with Δƒ at the right subband (to the subcarriers marked with dots with the hashed pattern fill).

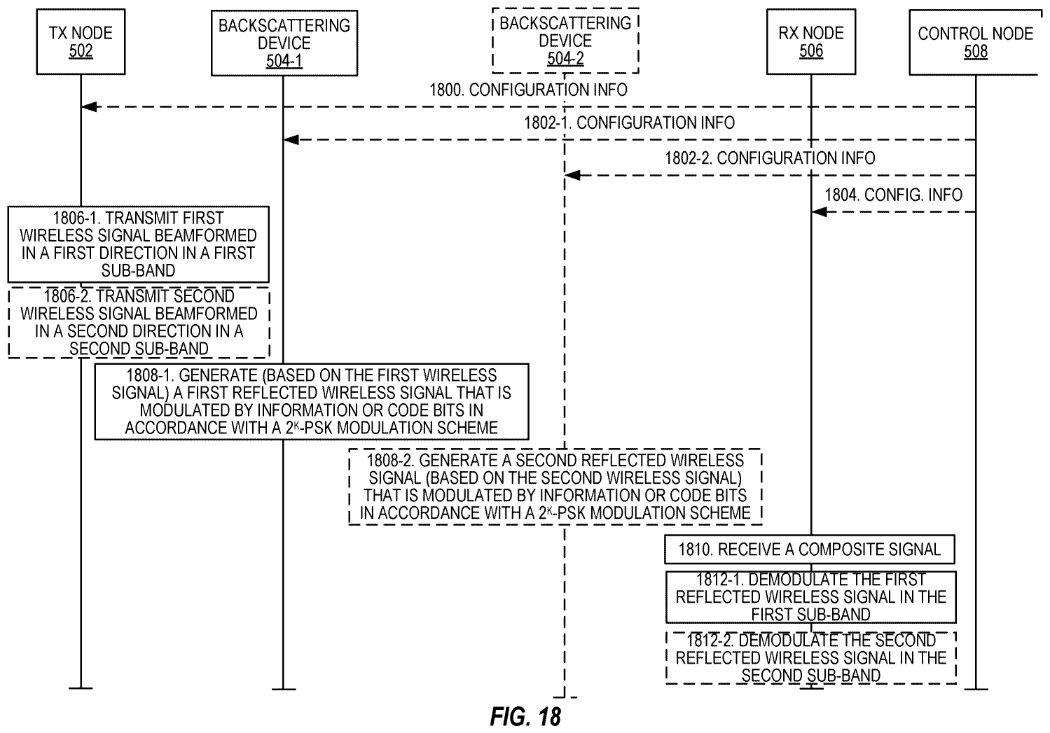

FIG. 18 illustrates the operation of the wireless system 500 in accordance with at least some of the embodiments above for subband OFDMA backscattering. Optional elements/steps are represented by dashed lines or boxes. As illustrated, in one embodiment, the control node 508 configures the transmit node 502, the backscattering devices 504-1 and 504-2, and/or the receive node 506 with one or more parameters for enabling the 2^{K}-PSK backscattering transmission/reception and/or multiple access operation as described herein (steps 1800, 1802-1, 1802-2, and 1804). For example, the control node 508 may configure the backscattering devices 504-1 and 504-2 with one or more parameters such as, e.g., respective values of K, M, N, and/or starting time for backscattered signal transmission. As another example, the control node 508 may configure the receive node 506 to receive backscattering signals from different backscattering devices (e.g., backscattering devices 504-1 and 504-2) in different frequency subbands, as described herein.

The transmit node 502 transmits a first wireless signal that is beamformed in a first direction in a first subband (step 1806-1) and a second wireless signal that is beamformed in a second direction in a second subband (1806-2). In one embodiment, the first and second wireless signals are the same signal but precoded, or beamformed, differently in different frequency subbands. In another embodiment, the first and second wireless signals are separate signals. In regard to separate signals, in an alternative embodiment, the first and second wireless signals are transmitted by separate transmit nodes. As described above, the first and second wireless signals are OFDM signals having a comb structure including both active and inactive subcarriers, as described above.

While the first wireless signal (i.e., first incident signal) is present at the antenna of the backscattering device 504-1, the backscattering device 504-1 generates a backscattered signal that is modulated by information or code bits in accordance with a 2^{K}-PSK modulation scheme (step 1808-1). Likewise, while the second wireless signal (i.e., second incident signal) is present at the antenna of the backscattering device 504-2, the backscattering device 504-2 generates a backscattered signal that is modulated by information or code bits in accordance with a 2^{K}-PSK modulation scheme (step 1808-2). The details of steps 1808-1 and 1808-2 are the same as those of steps 608-1 and 608-2 described above.

At the receive node 506, the receive node 506 receives a composite signal that includes the signal transmitted by the transmit node 502, the backscattered signal from the backscattering device 504-1 in the first subband, and, if present, the backscattered signal from the backscattering device 504-2 in the second subband (step 1810). The receive node 506 demodulates the backscattered signal from the backscattering device 504-1 in the first subband (step 1812-1) and, if present, demodulates the backscattered signal from the backscattering device 504-2 in the second subband (step 1812-2). Other than the subband aspect, the processing of the receive node 506 in steps 1810, 1812-1, and 1812-2 is the same as described above with respect to steps 610, 612-1, and 612-2.

While not illustrated in FIG. 18, OFDMA backscattering using different frequency offsets within the same subband may also be used.

### Multiple Access Backscattering with Multiple Carrier Emitters

In many interesting use cases for backscattering radio, such as warehousing and logistics, there can be very many backscattering devices in a limited area, and it is challenging to achieve high system capacity. In such cases, it is common to have multiple receivers and carrier emitters, since the range of backscatter radio is also very limited. However, carrier emitters will often interfere with the receivers, since the signal from the carrier emitters are much stronger than the reflections from the backscattering devices. While techniques like TDMA or FDMA can be used to alleviate the problem, this comes at the cost of spectrum efficiency and latency. Hence, it is desirable to develop methods to efficiently multiplex many backscattering devices and simultaneously employ many carrier emitters and many receivers within the same frequency band.

Systems and method are disclosed herein in which a control node coordinates a group of carrier emitters by allocating interlaced subcarriers and/or beamforming precoders and/or orthogonal cover codes for the carrier emitters in the group, allocates frequency shifts to the backscattering devices, and indicates inactive subcarriers to mitigate the effect of interference (from the carrier emitters and/or backscattering devices) on the receivers that receive the reflections of the backscattering devices.

Embodiments disclosed herein may mitigate the effect of interference when many carrier emitters and backscattering devices operate simultaneously in the same frequency band, thus increasing system capacity and spectral efficiency. Embodiments may be combined with traditional multiplexing techniques such as Time Division Multiple Access (TDMA) and/or Frequency Division Multiple Access (FDMA) and/or Spatial Division Multiple Access (SDMA) and/or other multi-antenna techniques.

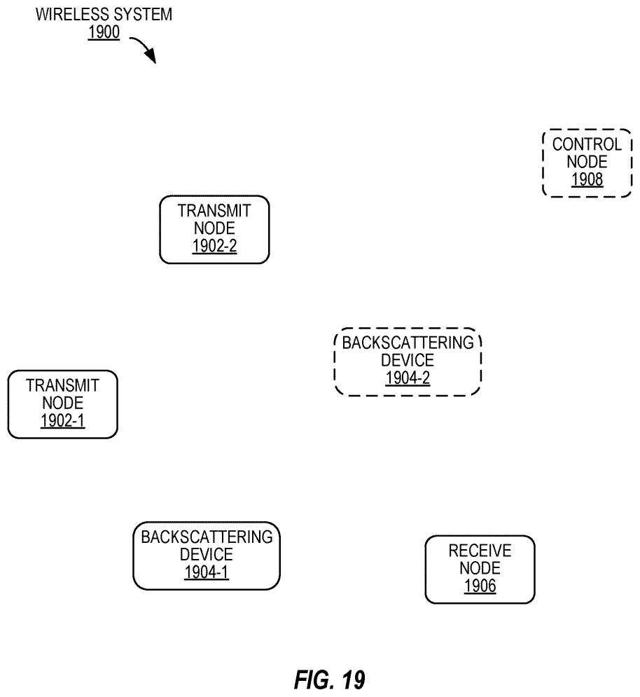

FIG. 19 illustrates a wireless system 1900 in accordance with some embodiments of the present disclosure. The wireless system 1900 is similar to that of FIG. 5 but including multiple transmit nodes (i.e., multiple carrier emitters). In the illustrated example, the wireless system 1900 includes transmit nodes 1902-1 and 1902-2, backscattering devices 1904-1 and 1904-2, a receive node 1906, and a control node 1908. In general, the transmit nodes 1902-1 and 1902-2 operate as described above with respect to the transmit node 502, the backscattering devices 1904-1 and 1904-2 operate as described above with respect to the backscattering devices 504-1 and 504-2, and the receive node 1906 operates as described above with respect to the receive node 506. The control node 1908 operates coordinate the operation of the transmit nodes 1902-1 and 1902-2, the backscattering devices 1904-1 and 1904-2, and the receive node 1906 as described below. Note that, while illustrated separately, the control node 1908 may alternatively be implemented in one of the other nodes (e.g., one of the transmit nodes 1902-1) or distributed across two or more of the other nodes (e.g., distributed across the two transmit nodes 1902-1 and 1902-2).

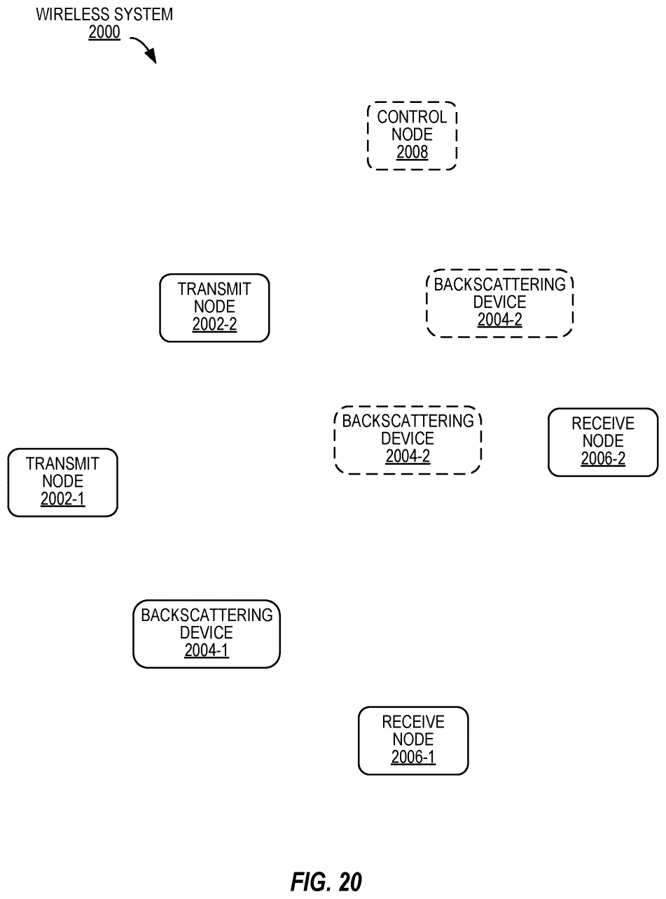

FIG. 20 illustrates a wireless system 2000 in accordance with another embodiment. This embodiment is similar to that of FIG. 19 but where there are multiple transmit nodes (i.e., multiple carrier emitters) and multiple receive nodes. In the illustrated example, the wireless system 2000 includes transmit nodes 2002-1 and 2002-2, backscattering devices 2004-1 to 2004-3, receive nodes 2006-1 and 2006-2, and a control node 2008. In general, the transmit nodes 2002-1 and 2002-2 operate as described above with respect to the transmit node 502, the backscattering devices 2004-1 to 2004-3 operate as described above with respect to the backscattering devices 504-1 and 504-2, and the receive nodes 2006-1 and 2006-2 operates as described above with respect to the receive node 506. The control node 2008 operates coordinate the operation of the transmit nodes 2002-1 and 2002-2, the backscattering devices 2004-1 to 2004-3, and the receive nodes 2006-1 and 2006-2 as described below. Note that, while illustrated separately, the control node 2008 may alternatively be implemented in one of the other nodes (e.g., one of the transmit nodes 2002-1) or distributed across two or more of the other nodes (e.g., distributed across the two transmit nodes 2002-1 and 2002-2).

In the embodiments of FIGS. 19 and 20, the backscattering devices 1904-1 and 1904-2 or 2004-1 to 2004-3 have different transmit nodes 1902-1 and 1902-2 or 2002-1 and 2002-2 and are located in proximity to each other. Therefore, without proper coordination, the backscattering devices 1904-1 and 1904-2 or 2004-1 to 2004-3 and transmit nodes 1902-1 and 1902-2 or 2002-1 and 2002-2 would create interferences seen at the receive node 1906 or receive nodes 2006-1 and 2006-2. One way to mitigate the interference is to have an interlaced comb structure as described above to ensure that the active subcarriers of the incident signal(s) and the subcarriers of the backscattered signals are orthogonal to one another.

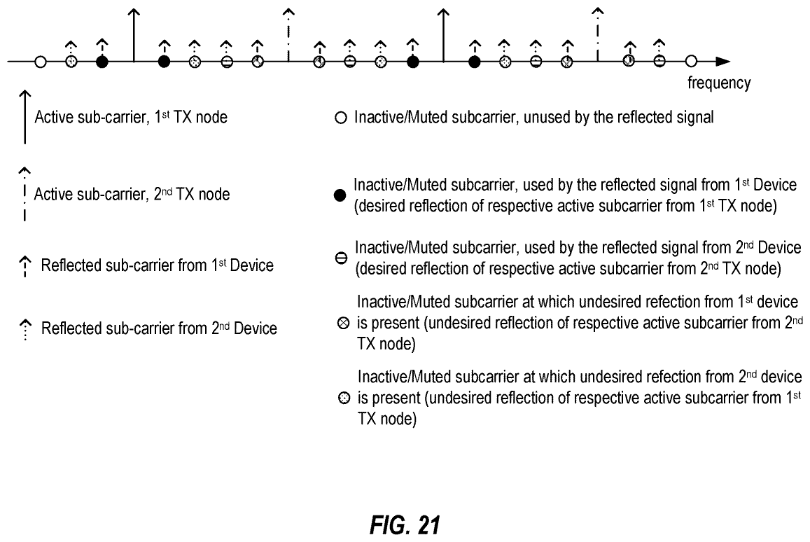

An example is illustrated in FIG. 21 where there are two transmit nodes (i.e., two carrier emitters), one transmitting a first wireless signal represented by the first and third vertical arrows starting from the left-hand side of the figure, and the other transmitting a second wireless signal represented by the second and fourth vertical arrows starting from the left-hand side of the figure. In the example of FIG. 21, there are also two backscattering devices that emit two respective backscattered signals, one having subcarriers offset from the active carriers of the two wireless signals by Δf and the other having subcarriers offset from the active carriers of the two wireless signals by 2Δf. The reflections to the sub-carriers marked with certain hashing (as indicated in FIG. 21) are un-intended reflections; thus, they will not be used by the receiver. The controller node 1908 or 2008 is used to coordinate the use of subcarriers with respect of the arrival timing of the signals at the receiver point of view.

In another embodiment, a guard subcarrier is added between each set of subcarriers to mitigate interference in case of large errors in time or/and frequency synchronization.

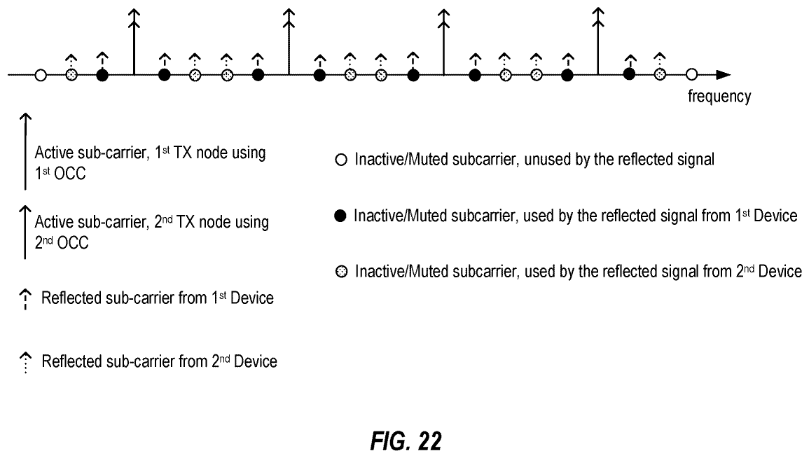

With use of beamforming and/or orthogonal cover codes, different carrier emitter signals can be allocated in the same subcarriers with the backscattering devices reflecting to different subcarriers. FIG. 22 illustrates an example in which two transmit nodes (e.g., transmit nodes 1902-1 and 1902-2 or transmit nodes 2002-1 and 2002-2) transmit their respective comb OFDM signals in the same subcarriers and one of the backscattering devices reflects with an offset of Δf and the other one reflects with an offset of 2Δf. Note that the different orthogonal cover codes would be accounted for at the receive node (e.g., by accounting for the orthogonal cover codes when compensating for phase shift).

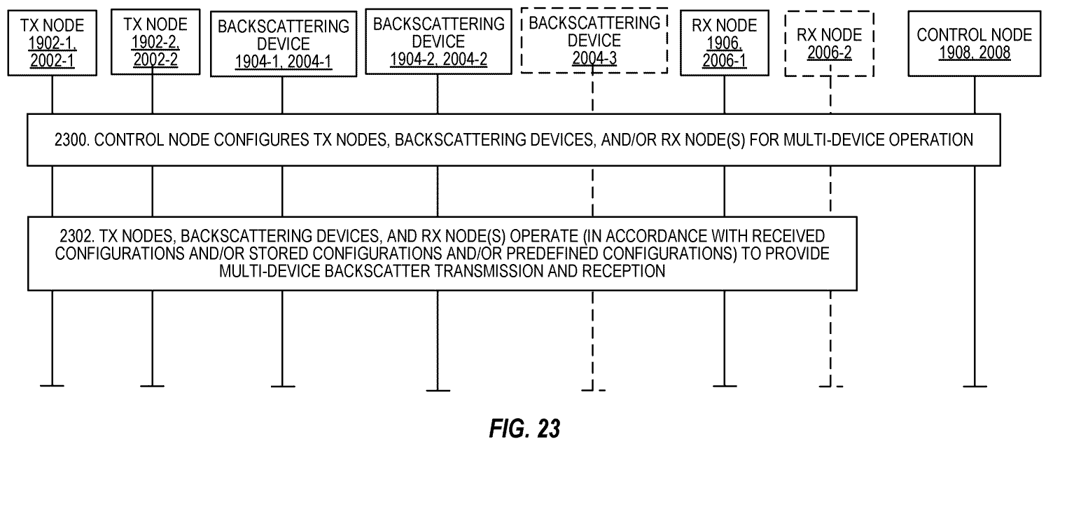

FIG. 23 illustrates the operation of the wireless system 1900 or 2000 in accordance with some embodiments of the present disclosure. As illustrated, the control node 1908 or 2008 configures the transmit nodes 1902-1 and 1902-2 or 2002-1 and 2002-2, the backscattering devices 1904-1 and 1904-2 or 2004-1 to 2004-3, and the receive node(s) 1906 or 2006-1 and 2006-2 for multi-device operation (step 2300). For example, the control node 1908 or 2008 may, e.g.:
configure each backscattering device 1904-p or 2004-p with any one or more of the following:
   a respective Mₚ value,
   a respective Nₚ value,
   a respective Kₚ value,
   a respective starting time for transmitting the respective wireless signal, and/or.
configure each of the transmit nodes 1902-1 and 1902-2 or 2002-1 and 2002-2 with any one or more of the following:
   subbands in which the transmit node is to use different beams directed to different backscattering devices or groups of backscattering devices, beam directions to be used by the transmit node for respective subbands,
   starting time for generating the respective backscattered signal (or conversely the starting time for the incident wireless signal to be reflected),
   configure the comb pattern (i.e., pattern of active and inactive subcarriers); and/or
configure the receive node 1906 or each of the receive nodes 2006-1 and 2006-2 with any one or more of the following:
   different subbands assigned to different backscattering devices or different groups of backscattering devices,
   starting time(s) of the wireless signals transmitted by the transmit nodes 1902-1 and 1902-2 and/or the transmit nodes 2002-1 and 2002-2,
   configure the comb pattern (i.e., pattern of active and inactive subcarriers) and/or the subcarriers used for the reflected signal(s) from the backscattering device(s).

The transmit nodes 1902-1 and 1902-2 or 2002-1 and 2002-2, the backscattering devices 1904-1 and 1904-2 or 2004-1 to 2004-3, and the receive node(s) 1906 or 2006-1 and 2006-2 operate in accordance with the received configurations (and/or stored configurations and/or predefined configurations) to provide multi-device backscattering signal transmission and reception in accordance with the embodiments described above (step 2302).

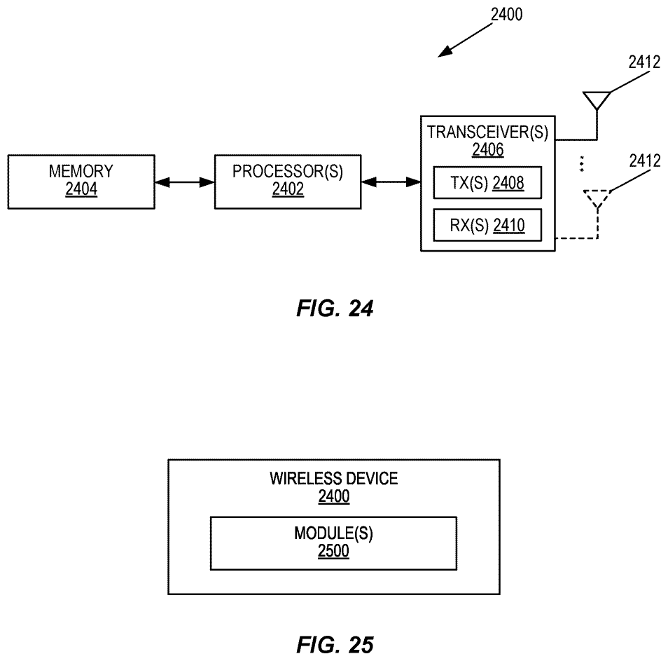

FIG. 24 is a schematic block diagram of a wireless device 2400 according to some embodiments of the present disclosure. The wireless device 2400 may be a transmit node (e.g., transmit node 502, 1902-1, 1902-2, 2002-1, or 2002-2), a backscattering device (e.g., backscattering device 504-p, 1904-p, or 2004-p), or a receive device (e.g., receive device 506, 1906, 2006-1, or 2006-2). Note that the control node 508, 1908, or 2008 may have a similar architecture. As illustrated, the wireless device 2400 includes one or more processors 2402 (e.g., CPUs, ASICS, FPGAS, and/or the like), memory 2404, and one or more transceivers 2406 each including one or more transmitters 2408 and one or more receivers 2410 coupled to one or more antennas 2412. Note that, for a backscattering device, the transceiver 2406 may have a simplified architecture such as, e.g., that illustrated in FIG. 1 (where the baseband signal generator may be seen as part of the processing circuitry 2402). The processors 2402 are also referred to herein as processing circuitry. The transceivers 2406 are also referred to herein as radio circuitry. In some embodiments, the functionality of the wireless device 2400 described above may be fully or partially implemented in software that is, e.g., stored in the memory 2404 and executed by the processor(s) 2402 or implemented in hardware or a combination of hardware. Note that the wireless device 2400 may include additional components not illustrated in FIG. 24 such as, e.g., one or more user interface components (e.g., an input/output interface including a display, buttons, a touch screen, a microphone, a speaker(s), and/or the like and/or any other components for allowing input of information into the wireless device 2400 and/or allowing output of information from the wireless device 2400), a power supply (e.g., a battery and associated power circuitry), etc.

In some embodiments, a computer program including instructions which, when executed by at least one processor, causes the at least one processor to carry out the functionality of the wireless device 2400 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 25 is a schematic block diagram of the wireless device 2400 according to some other embodiments of the present disclosure. The wireless device 2400 includes one or more modules 2500, each of which is implemented in software. The module(s) 2500 provide the functionality of the wireless device 2400 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a device for transmitting data using a 2^{K} Phase-Shift Keying, 2^{K}-PSK, modulation scheme, the method comprising:
exposing an antenna of the device to an incident wireless signal, the incident wireless signal being a multi-subcarrier wireless signal comprising a plurality of active subcarriers and at least two inactive subcarriers between at least one pair of adjacent active subcarriers from among the plurality of active subcarriers;
generating a binary sequence that comprises N repetitions of a 2^{K}-PSK representation of K information or code bits, the 2^{K}-PSK representation of the K information or code bits comprising one of 2^{K} cyclic shifts of a base sequence of 2^{K 1} zeros followed by 2^{K} 1 ones that is mapped to a particular binary sequence formed by the K information or code bits, wherein K is a positive integer value that is greater than or equal to 1 and N is a positive integer value that is greater than or equal to 1;
while exposing the antenna of the device to the incident wireless signal, modulating an impedance of the antenna between a first impedance value and a second impedance value at a switching rate that is R times a subcarrier spacing of the incident wireless signal in accordance with the generated binary sequence to thereby provide a backscattered signal that is modulated in accordance with a 2^{K}-PSK modulation scheme, wherein R is a positive even integer.

2. The method of claim 1 wherein the incident wireless signal is a multi-subcarrier wireless signal comprising the plurality of active subcarriers and at least two inactive subcarriers between each pair of adjacent active subcarriers from among the plurality of active subcarriers.

3. The method of claim 1 wherein, for each active subcarrier of the plurality of active subcarriers of the incident wireless signal, the backscattered signal comprises signal components located at f_{sc}±the switching rate, where f_{sc} is a center frequency of the active subcarrier.

4. The method of claim 1 wherein mappings between different binary sequences of K information or code bits and the 2^{K} cyclic shifts of the base sequence are predefined or preconfigured.

5. The method of claim 1 wherein at least one of N, K, and the switching rate is predefined or preconfigured for the device.

6. The method of claim 1 further comprising receiving, from a control node, information that configures at least one of N, K, and the switching rate for the device.

7. The method of claim 1 wherein the switching rate used by the device is different than a switching rate used by another device that simultaneously operates on the same incident wireless signal.

8. A device for transmitting data using a 2^{K} Phase-Shift Keying, 2^{K}-PSK, modulation scheme, the device comprising processing circuitry configured to cause the device
expose an antenna of the device to an incident wireless signal, the incident wireless signal being a multi-subcarrier wireless signal comprising a plurality of active subcarriers and at least two inactive subcarriers between at least one pair of adjacent active subcarriers from among the plurality of active subcarriers;
generate a binary sequence that comprises N repetitions of a 2^{K}-PSK representation of K information or code bits, the 2^{K}-PSK representation of the K information or code bits comprising one of 2^{K} cyclic shifts of a base sequence of 2^{K-1} zeros followed by 2^{K-1} ones that is mapped to a particular binary sequence formed by the K information or code bits, wherein K is a positive integer value that is greater than or equal to 1 and N is a positive integer value that is greater than or equal to 1; and
while exposing the antenna of the device to the incident wireless signal, modulate an impedance of the antenna between a first impedance value and a second impedance value at a switching rate that is R times a subcarrier spacing of the incident wireless signal in accordance with the generated binary sequence to thereby provide a backscattered signal that is modulated in accordance with a 2^{K}-PSK modulation scheme, wherein R is a positive even integer.

9. A method performed by a receiving device for reception of a backscattered signal from a device where the backscattered signal is modulated using a 2^{K} Phase-Shift Keying, 2^{K}-PSK, modulation scheme, the method comprising:
receiving a composite wireless signal, the composite wireless signal comprising a superposition of a first wireless signal from a transmitter device and a backscattered signal from a device, wherein the composite wireless signal is a multisubcarrier wireless signal and the backscattered signal is modulated in accordance with 2^{K}-PSK modulation scheme; and demodulating the backscattered signal.

10. The method of claim 9 wherein the composite wireless signal comprises:
a first set of subcarriers that correspond to a plurality of active subcarriers of the first wireless signal, the first wireless signal comprising the plurality of active subcarriers and at least two inactive subcarriers between each pair of adjacent active subcarriers; and
a second set of subcarriers that correspond to the backscattered signal, wherein:
the backscattered signal is a reflection of the first wireless signal from the device that is modulated by N repetitions of K information bits in accordance with a 2^{K}-PSK modulation scheme; and
the backscattered signal comprises, for each active subcarrier of the plurality of active subcarriers of the first wireless signal, signal components that correspond to subcarriers in the second set of subcarriers that are located at f_{sc}±frequency offset used by the device, where f_{sc} is a center frequency of the active subcarrier and the frequency offset is a multiple of a subcarrier spacing of the first wireless signal.

11. The method of claim 10 wherein demodulating the backscattered signal comprises, for each subcarrier in the second set of subcarriers that correspond to the backscattered signal:
applying a first phase and/or amplitude compensation to the subcarrier based on a phase and/or amplitude of a modulation symbol transmitted on a respective active subcarrier of the first wireless signal; and
applying a second phase compensation to the subcarrier based on a frequency offset between the subcarrier and the respective active subcarrier of the first wireless signal.

12. The method of claim 11 wherein demodulating the backscattered signal further comprises performing coherent combining over at least N-1 OFDM symbols over all of the subcarriers in the second set of subcarriers that correspond to the backscattered signal.

13. The method of claim 11 wherein demodulating the backscattered signal further comprises, for each subcarrier in the second set of subcarriers that correspond to the backscattered signal, applying an amplitude compensation to the subcarrier based on an amplitude of a modulation symbol transmitted on the respective active subcarrier of the first wireless signal.

14. The method of claim 9 wherein:
the composite wireless signal is a superposition of the first wireless signal from the transmitter device, the backscattered signal from the device, and a second backscattered signal from a second device; and
the method further comprises demodulating the second backscattered signal.

15. The method of claim 14 wherein the composite wireless signal further comprises:
a third set of subcarriers that correspond to the second backscattered signal, wherein:
the second backscattered signal is a reflection of the first wireless signal from the second device that is modulated by N2 repetitions of K2 information bits in accordance with a 2^{K2}-PSK modulation scheme, wherein N2 may or may not equal N and K2 may or may not equal K; and o the second backscattered signal comprises, for each active subcarrier of the plurality of active subcarriers of the first wireless signal, signal components that correspond to subcarriers in the third set of subcarriers that are located at f_{sc}±a second frequency offset used by the second device, where f_{sc} is a center frequency of the active subcarrier and the second frequency offset is a multiple of a subcarrier spacing of the first wireless signal and is different than the frequency offset used by the device.

16. The method of claim 15 wherein demodulating the second backscattered signal comprises, for each subcarrier in the third set of subcarriers that correspond to the second backscattered signal:
applying a first phase and/or amplitude compensation to the subcarrier based on a phase of a modulation symbol transmitted on a respective active subcarrier of the first wireless signal; and
applying a second phase compensation to the subcarrier based on a frequency offset between the subcarrier and the respective active subcarrier of the first wireless signal.

17. (canceled)

18. The method of claim 9 further comprising receiving, from a control node, information that configures at least one of N, K, and the frequency offset for the device.

19. The method of claim 9 wherein:
the composite wireless signal comprises:
the superposition of the first wireless signal from the transmitter device and the backscattered signal from the device in a first sub-band of the composite signal, the backscattered signal being modulated in accordance with a 2^{K}-PSK modulation scheme; and
a superposition of the first wireless signal from the transmitter device and a second backscattered signal from a second device in a second sub-band of the composite signal, the second backscattered signal also being modulated in accordance with a 2^{K}-PSK modulation scheme;
demodulating the backscattered signal comprises demodulating the reference signal in the first sub-band; and
the method further comprises demodulating the second backscattered signal in the second sub-band.

20. (canceled)

21. The method of claim 19 further comprising receiving, from a control node, information that indicates the first sub-band used by the device and the second subband used by the second device.

22. A receiving device for reception of a backscattered signal from a device where the backscattered signal is modulated using a 2^{K} Phase-Shift Keying, 2^{K}-PSK, modulation scheme, the receiving device comprising processing circuitry configured to cause the receiving device
receive a composite wireless signal, the composite wireless signal comprising a superposition of a first wireless signal from a transmitter device and a backscattered signal from a device, wherein the composite wireless signal is a multi-subcarrier wireless signal and the backscattered signal is modulated in accordance with 2K-PSK modulation scheme; and
demodulate the backscattered signal.

23-29. (canceled)
